(19) United States
(12) Patent Application Publication
(10) Pub. No.: US 2005/0279010 A1
(43) Pub. Date: Dec. 22, 2005

(54) Heated bobber for use in ice fishing

(75) Inventor: Robert D. Krog, Aurora, MN (US)

Correspondence Address: NIKOLAI & MERSEREAU, P.A., 900 SECOND AVENUE SOUTH, SUITE 820, MINNEAPOLIS, MN, 55402, US

(73) Assignee: KROG INDUSTRIES, Aurora, MN (US)

(21) Appl. No.: 10/874,095

(22) Filed: Jun. 22, 2004

(51) Int. Cl. A01K 93/00

(52) U.S. Cl. 43/44.87

(57) ABSTRACT

A fishing bobber incorporates a heating element in the interior thereof that is adapted to be supplied with current from an external power pack by way of a water impervious plug and jack connection. When used in ice fishing applications, the heated bobber functions to keep the water from refreezing in the ice hole. When a fish strikes and drags the bobber down into the water, the plug and jack separate so that the battery pack and lead wires are not dragged into the ice hole.

### BACKGROUND OF THE INVENTION

I. Field of the Invention

This invention relates generally to fishing tackle, and more particularly to a heated bobber for use in ice fishing to inhibit freeze-over of the ice hole.

II. Discussion of the Prior Art

Ice fishing is a very popular sport in northern climates where lakes and streams freeze over in the winter months. An ice auger or other tool may be used to drill or otherwise form a hole through the ice through which a baited hook, a line and a sinker may be dropped in an attempt to catch fish. Ice fisherman are also known to use a so-called “tip-up” which provides a visual indication to the fisherman that a fish may have been caught. Such a tip-up can be observed at a distance in those instances where the fisherman may have moved to a shelter to escape the cold. In instances where the fisherman positions himself right next to the ice hole, a conventional bobber may be used to indicate when a fish has struck.

A difficulty arises in the event that the temperature is such that the ice hole freezes over while the fisherman is waiting for such a strike to occur. With a layer of ice formed in the previously drilled hole, a catch cannot be landed without first chipping through the layer of ice that may have formed.

Various prior art patents have been granted that are directed to various approaches for preventing an ice fishing hole from freezing over. For example, the Dowdle U.S. Pat. No. 5,844,210 discloses a ring that is adapted to be inserted into the ice hole, the ring being resistively heated by current flowing through it from a battery source. The Sykes U.S. Pat. No. 5,540,009 describes an arrangement in which the fishing line is passed through a tube that is adapted to be heated by current from a battery source. Apparently, the entire assembly is arranged to float in the ice hole. A somewhat simpler arrangement is shown in FIG. 3 of the Sykes '009 patent where the heated pipe is press-fit through a foam material which is arranged to float within the ice fishing hole. A heating element is wrapped about the pipe and is powered by a battery pack.

Another arrangement is shown in U.S. Pat. No. 4,612,910 to Williams where the apparatus for maintaining the ice hole open is heated by a flame from a can of fuel, such as Sterno. It is not explained how one can simultaneously fish and have that heater unit floating in the ice hole.

A need exists for a simpler, less expensive and more practical way of maintaining an ice fishing hole patent over prolonged periods of time and the present invention meets that need.

### SUMMARY OF THE INVENTION

The above-described problems and deficiencies of the prior art are overcome by the present invention in which there is provided an electrically heated bobber which when floating on the surface of the water in the ice hole delivers sufficient heat energy (calories) to prevent freeze-over. The bobber comprises a hollow, water-tight buoyant member having a means for securing the bobber to a fishing line at a desired location along the length thereof and which contains within the hollow interior thereof a heating element that connects to an electrical terminal that extends through the bobber's wall. A source of electrical current, such as a battery pack, is connected by electrical wires to the electrical terminal built into the bobber by means of a plug or jack that releasably mates with the electrical terminal. Current flowing through the heating element produces the desired heat energy for preventing freeze-over.

When a fish strikes the hook suspended from the bobber, the bobber is pulled downward into the water causing the plug or jack to pull free from the electrical terminal on the bobber so that now the bobber functions in the usual manner to signal the strike and the fisherman can set the hook and play the fish in the usual manner. Once the fish is landed, the hook will be re-baited and the electrical connection from the battery to the bobber is restored.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which like numerals in the several views refer to corresponding parts.

FIG. 1 is a cross-sectional view taken through an ice hole;

FIG. 2 is a side view of the fishing bobber embodying the present invention;

FIG. 3 is a top view of the bobber of FIG. 2;

FIG. 4 is a partial, enlarged view of the interior of the bobber showing the electrical terminal by which current may be delivered to the heating element contained within the bobber; and

FIG. 5 is an enlarged perspective view showing the placement of the heating element within the bobber.

### DESCRIPTION OF THE PREFERRED EMBODIMENT

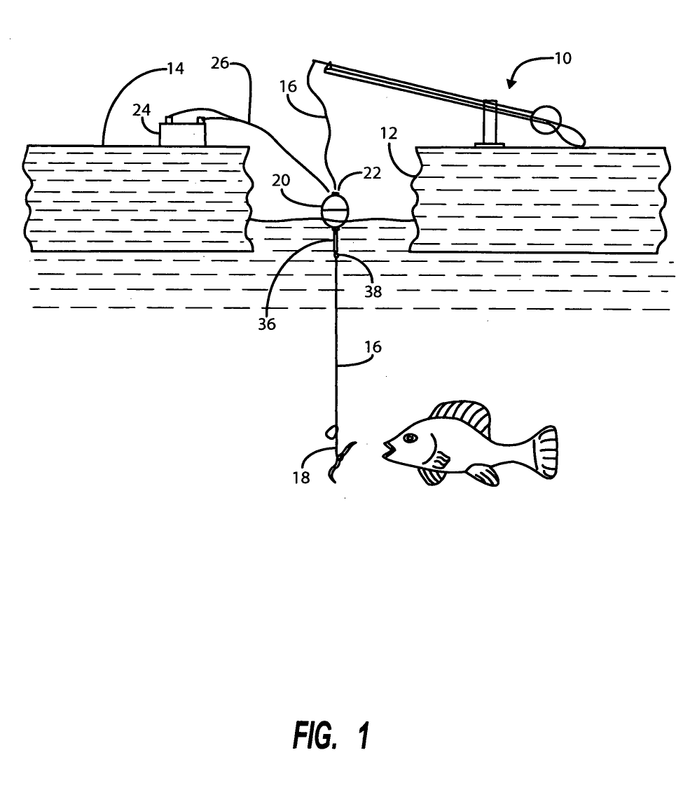

Referring first to FIG. 1, there is shown an ice fishing rod and reel 10 located adjacent to a hole 12 formed through the ice 14 and with the fishing line 16 extending through the hole and into the water. Secured to the end of the line is a baited hook 18. The depth to which the hook descends is set by the placement of a buoyant bobber 20 that is suitably clamped to the line 16 in a way that allows easy adjustment of the amount of line extending below the bobber.

As will be explained in greater detail hereinbelow, contained within the bobber 20 is an electrical heating element that is adapted to be connected through a suitable waterproof female electrical coaxial socket 22 that extends through the bobber's wall. A source of electrical current which may be a DC battery pack or other portable power source 24 is connected by insulated electrical wires 26 to a male plug that is adapted to mate with the coaxial socket 22 formed through the bobber's wall. In use, then, with electrical current being supplied to the heating element contained within the bobber 20, and with the bobber floating on the surface of the water within the ice hole, sufficient heat energy is generated to prevent freezing of the water in the hole. When a fish grabs the bait and is hooked, the tug on the line as the fish attempts to pull free is sufficient to pull the bobber below the level of the water and, in doing so, causes the electrical plug affixed to the wires 26 to become disconnected from the electrical terminal 22 of the bobber so as not to interfere with the landing of the fish in the usual manner.

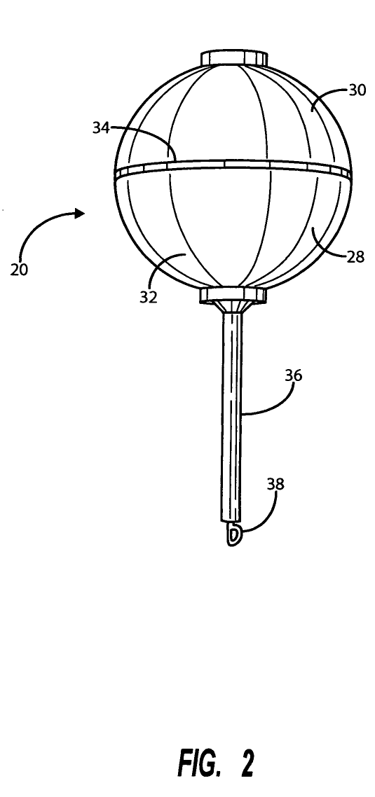

Referring next to FIG. 2, the bobber constructed in accordance with the present invention is seen to comprise a hollow, watertight buoyant member 28, preferably made in a molding operation from a suitable plastic, and including first and second hemispherical halves 30 and 32 that are joined together about a parting line 34 by means of a suitable adhesive or preferably in a laser-bonding operation. Extending downward from the bottom of the hemispherical half 32 is a cylindrical rod 36 and affixed to the lower end of the cylindrical rod 36 is a clasp member 38 that is adapted to fit around the fishing line 16 in FIG. 1. When placed in water, the weight of the rod 36 tends to orient the bobber so that the hemispherical half 34 floats above the water line.

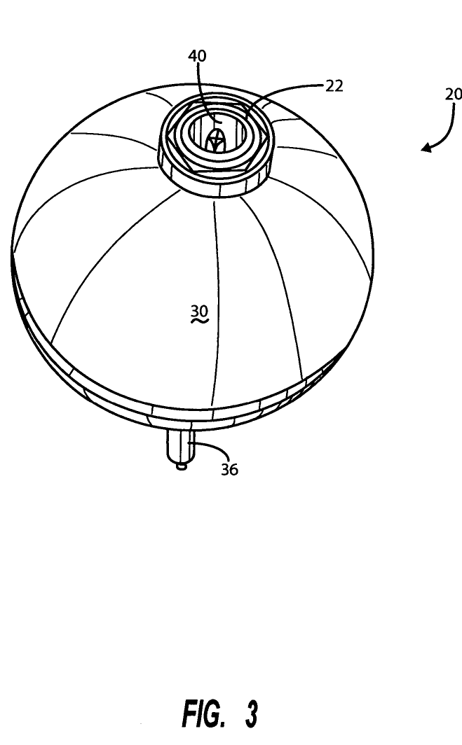

Turning next to FIG. 3, there is shown a top view of the bobber 20 of FIG. 2. It can be observed that the upper hemispherical half is provided with an electrical terminal 22 that penetrates through the plastic wall and is scaled about its perimeter. Here, the electrical terminal 22 comprise a female socket 40 that is adapted to receive a coaxial male plug therein. The terminal has first and second contacts that are electrically insulated from one another. Without limitation, the female terminal may comprise a commercially=available coaxial power jack sold through electronic supply stores. The contacts are suitably plated so as not to corrode when exposed to moisture. Moreover, the terminal is water tight, preventing the bobber 20 from filling with water when the bobber becomes submerged.

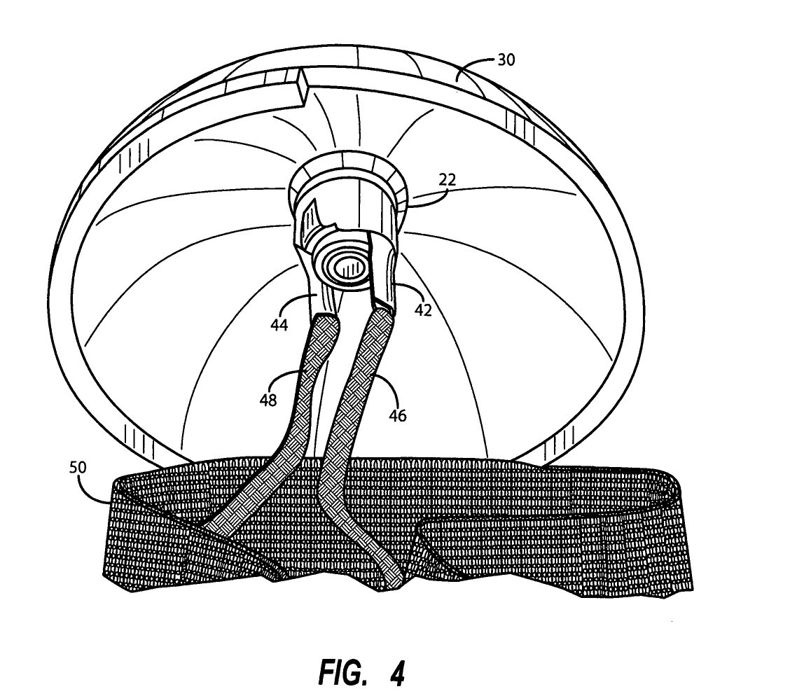

FIG. 4 is a view of the inside of the upper hemispherical portion 30 of the bobber 20. Here it can be seen that the terminal 22 includes first and second contacts 42 and 44 to which are soldered conductive bus straps 46 and 48 that lead and connect to a heating element 50. While a variety of known low resistance heating elements may be employed, one determined to be particularly suitable is a strip of GORIX® pyrolized, carbonized woven or knitted polymeric fabric. When an electrical current is made to flow through the carbonized fabric, it becomes heated. Those interested in gaining a greater understanding of the manner in which the GORIX fabric is produced may refer to the Gordon et al. U.S. Pat. No. 6,172,344 which is assigned Gorix Limited of Great Britain.

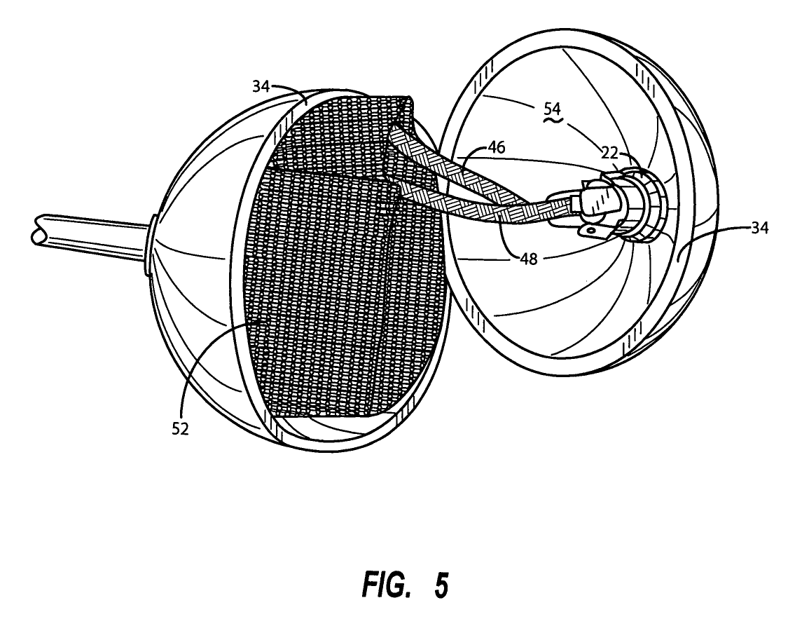

The bus straps 46 and 48 are connected to opposed ends of the heating element 50 and, as shown in FIG. 5, the heating element is placed within the bobber such that its outer major surface 52 is in abutting contact with the interior wall 54 of the bobber. When the semicircular halves are joined about their parting line 34, the heating element will reside within a hollow, watertight, buoyant chamber and with the electrical terminals thereof connected by the bus straps 46 and 48 to the terminal 22 which penetrates through the upper hemispherical half 30 of the bobber 20. When the two-terminal plug on the end of the wires 26 in FIG. 1 is inserted into socket 40 of the terminal 22 on the bobber, a series electrical circuit is completed from the battery pack 24 (FIG. 1), through the wires 26 and the bus straps 46 and 48 to the opposed terminal ends of the GORIX heating element 50. As a result, the bobber becomes heated, giving off heat energy to the water within the ice hole to maintain the hole substantially ice free.

While the embodiment illustrated in the drawings hereof show a female electrical terminal built into the bobber, those skilled in the art will appreciate that a male terminal may also be used on the bobber 20 to mate with a female terminal soldered or otherwise connected to the ends of the wires 24.

The drawings of FIGS. 2-5 illustrate the manner in which a conventional plastic bobber is cut in half in order to install the heating element therein. While this approach proves satisfactory in producing a working prototype of the invention, in production the plastic shell is to be molded or otherwise formed about the heating element. Alternatively, the upper and lower hemispherical halves 30 and 32 can be separately molded and then joined together after the heating element has been inserted into the interior cavity defined by the two hemispherical halves and the connections to the coaxial terminal have been made.

Further, while the drawings illustrate a spherical bobber, it is to be appreciated that the shape thereof is somewhat of a matter of choice such that the bobber may assume a variety of geometrical shapes currently found in conventional (unheated) fishing bobbers.

It has been determined that a battery pack comprising four AA size battery cells will operate for several hours to keep ice from forming in the hole even when the ambient temperature reaches as low as 0° F.

As to a further discussion of the manner of usage and operation of the present invention, the same should now be apparent from the above description. Accordingly, no further discussion relating to the manner of usage and operation need be provided.

With respect to the above description, then, it is to be realized that the optimum dimensional relationships for the parts of the invention, to include variation in size, materials, shape, form, function and manner of operation, assembly and use, are deemed readily apparent and obvious to one skilled in the art, and all equivalent relationships to those illustrated in the drawings and described in the specification are intended to be encompassed by the present invention. Further, since numerous modifications and changes will readily occur to those skilled in the art, it is not desired to limit the invention to the exact construction and operation shown and described and, accordingly, all suitable modifications and equivalents my be resorted to, falling within the scope of the invention.

1. A fishing bobber for use in ice fishing comprising:
(a) a hollow, watertight buoyant member;
(b) an attachment device affixed to the buoyant member adapted to secure the buoyant member to a fishing line; and
(c) an electrical heating element disposed in the hollow, watertight buoyant member, the heating element being connected to an electrical terminal mounted on said member.

2. The fishing bobber as in claim 1 and further including an electrical current source adapted to be releasably coupled to said electrical terminal for supplying current to the electrical heating element.

3. The fishing bobber as in claim 2 wherein the electrical current source is releasably coupled to the electrical terminal by flexible conductors having one of a male plug and a female jack affixed to one end thereof that is adapted to mate with said electrical terminal.

4. The fishing bobber as in claim 1 wherein the heating element conforms to a predetermined portion of an interior surface of the hollow buoyant member.

5. The fishing bobber as in claim 4 wherein the heating element comprises an electrically conductive fabric.

6. The fishing bobber as in claim 5 wherein the fabric is a woven pyrolized polymer material.

7. The fishing bobber as in claim 1 wherein the hollow, buoyant member is generally spherical.

8. The fishing bobber as in claim 1 wherein the hollow buoyant member is generally ovaloid.
